(19) United States
(12) Patent Application Publication
(10) Pub. No.: US 2022/0403285 A1
(43) Pub. Date: Dec. 22, 2022

(54) METHOD AND APPARATUS FOR PLANT OIL EXTRACTION USING A HEATED FLUID OBTAINED FROM A CAVITATION APPARATUS

(71) Applicant: UNITED CAVITATION INTEGRATED TECHNOLOGIES, Cranford, NJ (US)

(72) Inventors: Douglas S. HIRSH, Skaneateles, NY (US); Radovan HRINDA, Clark, NJ (US)

(21) Appl. No.: 17/776,610

(22) PCT Filed: Nov. 10, 2020
(86) PCT No.: PCT/US2020/059819

§ 371 Date: May 13, 2022

Related U.S. Application Data
(60) Provisional application No. 62/934,690, filed on Nov. 13, 2019.

(51) Int. Cl. C11B 1/10; B01D 3/34; B01D 3/10; C11B 1/14

(52) U.S. Cl. CPC C11B 1/10; B01D 3/346; B01D 3/10; C11B 1/14

(57) ABSTRACT

An apparatus and method of use employs a multiple displacement evacuation tank and a cavitation apparatus. Heated fluid from the cavitation apparatus is used to treat a plant material to obtain a purified oil product therefrom. The cavitation apparatus output is used to both heat the multiple displacement evacuation tank contents and supply a feed to the multiple displacement evacuation tank for oil product manufacture. The fluid is preferably a lipid emulsion and the plant material is preferably a hemp material that allows for recovering of the cannabinoids therefrom.

### FIELD OF THE INVENTION

The invention relates to a method of using a fluid, for example a lipid emulsion, for a cavitation equipment producing heated or cooled levels of the lipid emulsion, containing at least one engine, a house, the lipid emulsion liquid to be heated, and a cavernous body rotating in the lipid emulsion liquid to be heated, and driven by an external engine for the extraction of plant oil from raw plants. Additionally, the cavitated effluent is processed through a multiple displacement evacuation tank to separate the lipid emulsion and various contaminants from the plant oil and recover purified plant oil for use.

### BACKGROUND ART

The phenomenon of cavitation to produce heat in liquids such as a lipid emulsion fluid is well known in the art.

An example of a cavitation system using a rotating body for producing heated liquids is presented in U.S. Pat. No. 3,720,372 to Jacobs. Other patented solutions using the cavitation phenomenon to produce heat were developed in 1950s, especially in the United States. A well-known patent is U.S. Pat. No. 4,424,797 to Perkins. This patent is a developed and state of the art version of the solutions described in U.S. Pat. No. 2,683,448 to Smith. An improvement was also disclosed in U.S. Pat. No. 4,779,575, also to Perkins.

Cavitational devices are also described in U.S. Pat. Nos. 5,188,090 and 5,385,298 to Griggs. In these devices, a cylindrical body is placed into the housing of the device, and a cloak is provided with cavitational bores. The liquid to be heated is placed into the cylindrical free space between the rotating body with cavitational bores and the internal cloak of the housing; the pressure and temperature of the sterilized lipid emulsion liquid increases while the cavitational body is rotating. The Griggs patents are incorporated by reference herein in their entirety.

Other cavitation devices are disclosed in U.S. Pat. No. 6,164,274 to Giebeler, U.S. Pat. No. 6,227,193 to Selivanov, and the Russian patent No. RU 2,262,644. Another approach from a cavitation standpoint is shown in United States Published Patent Application No. 2010/0154772 to Harris. In this approach, the helical loops of the rotating rotor and the internal cloak of the housing jointly result in cavitational heat production, while the rotor is rotating. The Fabian publication WO2012/164322A1 teaches a similar cavitation apparatus.

The prior art systems described above have a number of disadvantages, including being inefficient and generating noise, primarily due to these concepts addressing the cavitation process as a two dimensional process. One aim of cavitation apparatus is to eliminate the disadvantages of the known solutions and the harmful cavitational effects in cavitation devices, to eliminate destructive forces internal to the cavitation process, to improve efficiency, to reduce cavitation noise through a three-dimensional vector approach, and to further separate a lipid emulsion, and process by-products from plant oil that is used in connection with the lipid emulsion for plant oil recovery and purification.

The prior art also discloses methods of purifying materials. U.S. Pat. No. 3,463,339 discloses removal of soluble iron contaminants from hydrocarbon oils by treatment with aqueous sulfuric acid, followed by separating the iron-free oil from the aqueous acid phase to which the iron has been transferred.

U.S. Pat. No. 3,459,658 discloses removal of iron contaminants from hydrocarbon oils by contacting iron-contaminated oil with an aqueous medium containing an acid and a reducing agent capable of reducing iron from the ferric to the ferrous state.

U.S. Pat. No. 5,271,863 discloses removal of soluble iron contaminants from hydrocarbon oils by contact with a Mannich reaction product, which forms a complex with the iron species.

U.S. Pat. No. 10,435,632 to Quintanilla et al. teaches another method of removing iron contaminants from hydrocarbon oils. This patent uses a specifically defined liquid as a two tail lipid emulsion. The teachings of this patent are incorporated in their entirety by reference as the emulsion taught in this patent is one type of fluid used in the invention described below.

However, there is still a need to provide improved methods for recovering oils from materials in an efficient and cost effective manner.

### SUMMARY OF THE INVENTION

In one mode of the invention, a device and method are provided that reduces the level of heavy metals and microorganisms in a lipid emulsion containing a two tail lipid. This emulsion is that disclosed in the Quintanilla patent discussed above. The method comprises taking the lipid emulsion and processing it using a cavitation apparatus of the kind shown in U.S. Pat. No. 10,240,774 entitled Method and Apparatus for Heating and Purifying Liquids to Hirsch et al. This patent is also incorporated in its entirety by reference. This processing improves the purity of the lipid emulsion and effectively sterilizes it if not already sterile when being fed to the cavitation apparatus. The treated lipid emulsion can then function as a feed for extracting oils from plant matter as detailed below.

The lipid emulsion aqueous fluid is used in the cavitation apparatus described above for producing a heated lipid emulsion and for sterilizing the lipid emulsion, if need be. The cavitation apparatus includes at least one engine, a housing, a feed as the lipid emulsion liquid to be heated, and one or more cavernous cavitation bodies rotating in the lipid emulsion liquid to be heated and driven by the engine. The invention includes the procedure for the operation of the equipment. The solution according to the invention advantageously eliminates the otherwise harmful and eroding features of cavitation, while using the generated cavitation bubbles to change the thermal conditions of lipid emulsion, for raw oil extraction from plant materials, either previously processed or unprocessed.

More particularly, the invention is characterized in that a constricting form is installed in the housing, the constricting form contains cavitation steps, directional and bounce bumpers, and a free constricting funnel for the lipid emulsion liquid to be heated between the constricting form and the cavitation body allowing for velocity and directional control of formed cavitation bubbles critical for process integrity and reduction/elimination of the destructive forces associated with the cavitation process. The method for the use of the cavitation equipment forms also part of the invention, as integral components of the overall cavitation system enhance noise reduction, and process efficiency.

Additionally, a multiple displacement evacuation tank is combined with the cavitation apparatus. This combination of components permits the heated lipid emulsion from the cavitation apparatus to mix with plant matter and this mixture is introduced into the tank so that the heat from the heated lipid emulsion is used for evaporation, distillation, condensation, and sedimentation involving the effluent from the cavitation apparatus. The lipid emulsion used for heating purposes can be recycled back to the cavitation apparatus for reheating. The mixture of the plant matter and effluent from the cavitation apparatus when fed to tank produces a number of different product streams, a purified lipid emulsion stream, which can also be recycled to the cavitation apparatus or used for purposes outside the cavitation apparatus operation, a concentrated and purified plant oil stream for recovery, one or more sedimentation stream for disposal or some other application.

More particularly, the multiple displacement evacuation tank includes a plurality of ports for inputs and outputs, multiple chambers for evaporation, distillation, condensation, and sedimentation of a cavitated fluid for discharge, and control points to manipulate the cavitated fluid passing through the multiple displacement evacuation tank for purification.

The multiple chambers include an upper chamber that allows for condensation of cavitated fluids heated and discharge of condensed cavitated fluids, a middle heating chamber that is used for heating fluid under purification for evaporation, the middle heating chamber also configured for extracting heat from the cavitated fluid flowing through the middle heating chamber, and a lower chamber that collects fluid passing from the upper chamber and through the middle heating chamber, the lower chamber allowing for separation of fluid via mass weight through distillation and sedimentation, the lower chamber optionally providing a capability of outputting fluid from the lower chamber for recycle to the upper chamber.

The invention also includes a system for extracting oil from plant material that uses an apparatus for heating a fluid using cavitation. The apparatus has a housing having an inlet for fluid to be heated and an outlet to discharge the heated fluid from the housing. Also provided is an external rotor adapted to be fixed on a motor shaft extending in a axial direction, the external rotor contained in the housing and adapted to rotate within the housing, the external rotor having a plurality of cavitation bores arranged in an outer surface thereof and the external rotor arranged within the housing to form a fluid heating zone between the outer surface of the external rotor and an inner surface of the housing that faces the outer surface of the external rotor. The inner surface of the housing extends in the axial direction and a housing circumferential direction, wherein the inner surface of the housing facing the bore-containing outer surface of the external rotor has a plurality of first funnel zones extending along the inner surface of the housing and in the housing circumferential direction. The plurality of first funnel zones are laterally spaced apart from each other in the axial direction with each first funnel zone terminating in a first discharge zone. Each first funnel zone includes a first ramp, each first discharge zone offset in the housing circumferential direction from an adjacent first discharge zone, fluid entering the housing being heated by interaction with the first funnel zones and first ramps, bores in the external rotor, and external rotor rotation.

The cavitation apparatus is combined with the multiple displacement evacuation tank so that the fluid output from the cavitation apparatus can be used as a feed for plant oil recovery and a source of heat for the tank. The output of the cavitation apparatus is directed to a strainer enclosure, which is adapted to receive not only the output from the cavitation apparatus but also an input of plant material so as to create a mixture of the fluid and plant material. The mixture is fed to the multiple displacement evacuation tank so that oils in the mixture can be recovered using the multiple displacement evacuation tank.

The invention also includes a method of recovering oil from plant material using a multiple displacement evacuation tank described above. In this method, fluid is introduced into the upper chamber of the tank. The fluid is then dispersed in a controlled manner to facilitate evaporation, distillation, condensation, and sedimentation of the fluid and contamination by passing the fluid through the middle heating chamber of the tank. Fluid and contaminants are then discharged from the lower chamber of the tank, wherein plant oil is separated from contaminants for plant oil recovery. Fluid can be recycled from one or both of the lower chamber and middle heating chamber to the multiple displacement evacuation tank.

Another aspect of the method is to use the cavitation apparatus and supply fluid to the cavitation apparatus for heating to produce a heated fluid. The heated fluid is mixed with plant material to create a heated fluid-plant material mixture for introduction into the upper chamber of the tank. The heated fluid or the heated fluid plant material mixture can also be supplied to the middle heating chamber for heating of the heated fluid-plant mixture introduced into the upper chamber. Plant oil is then recovered from the plant material along with contaminants, and heated fluid. The heated fluid is optionally recycled to the cavitation apparatus along with discharge from the middle heating chamber. Preferably, the fluid is water, a lipid emulsion, or a sterilized lipid emulsion, the plant material is hemp, and the plant oil is a cannabinoid.

Additional features of the multiple displacement evacuation tank and method of the invention are provided below.

In accomplishing the function of heating the fluid from the upper chamber, the middle heating chamber can have a sealed chamber having a plurality of tubes positioned in a space formed by the sealed chamber. The sealed chamber has a first inlet and first outlet for the space and each of the tubes have an inlet in communication with the upper chamber so as to be configured to received fluid from the upper chamber. An outlet of the tubes is in communication with the lower chamber to supply fluid to the lower chamber. Heated fluid is supplied to the space heating fluid passing through the plurality of tubes.

In accomplishing the function of the upper chamber, the upper chamber can have a first diffuser configured to disperse fluid entering the upper chamber and a second diffuser configured to disperse fluid in the upper chamber for entering the middle heating chamber. A condensation plate and condensation collection pan are provided and positioned above the first diffuser. The condensation collection pan in communication with an evaporation tube passing through the middle heating chamber. The upper chamber has an outlet in communication with the condensation collection pan, wherein evaporated fluid passing through the evaporation tube from the middle heating chamber condenses on the condensation plate and is collected on the condensation collection pan for discharge through the outlet in the upper chamber. The upper chamber can include one or more ports for introduction of cold fluid and/or compressed air to facilitate evaporation and condensation and/or for evacuation of the upper chamber.

To accomplish the function of the lower chamber, the lower chamber can include a first chamber in communication with the middle heating chamber and having at least one outlet. A second chamber is also part of the lower chamber, the second chamber in communication with the first chamber and having at least one outlet. The first chamber allows for sedimentation of fluid from the middle heating chamber to separate plant oil from the fluid received from the middle heating chamber. The first outlet is positioned in the first chamber to direct plant oil to the second chamber for recovery via the at least one outlet in the second chamber. The first chamber of the lower chamber can have an additional outlet to either recycle fluid from the middle heating chamber or recover the fluid from the middle heating chamber or discharge sedimentary contamination from the first chamber.

In terms of the method of using the tank and the cavitation apparatus to produce a plant oil, the plant material used to produce the plant oil can be used in its raw form or in a broken-down form, for example, shredding, so as to provide an increase in surface area.

### BRIEF DESCRIPTION OF THE DRAWINGS

FIG. 1A is a schematic of one embodiment of an overall system using the cavitation apparatus and multiple displacement evacuation tank.

FIG. 1B is a schematic of another embodiment of an overall system using the cavitation apparatus and multiple displacement evacuation tank.

FIG. 2 is a perspective view of one embodiment of the cavitation apparatus.

FIG. 3 is a sectional view of the cavitation head of FIG. 2.

FIG. 4 is a different sectional view of the cavitation head of FIG. 2

FIG. 5 shows an enlarged sectional view of the cavitation bore part of the cavitation head of FIG. 2.

FIG. 6 shows an enlarged sectional view of the ramp part of the cavitation head of FIG. 2.

FIG. 7 shows an angular displacement drawing for the cavitation ramps of the cavitation head of FIG. 2

FIG. 8 is a diagram showing a tertiary view of cavitation fluid flow for the cavitation apparatus of FIG. 2.

FIG. 9 shows an example of the cavitation ramp positioning for the cavitation apparatus of FIG. 2.

FIG. 9A shows an enlarged sectional view of one detail of the cavitation ramp detail of the cavitation apparatus of FIG. 2.

FIG. 9B shows an enlarged sectional view of another detail of the cavitation ramp detail of the cavitation apparatus of FIG. 2.

FIG. 10 is a Table showing characteristics of fluid evaporation & condensation measurement based on different temperatures.

FIG. 11 provides a more detailed schematic of the multiple displacement evacuation tank (MDET) of FIG. 1A.

FIG. 12 shows a heating and evaporation plate detail of the MDET of FIG. 11.

FIG. 13 shows a diffuser plate detail of the MDET of FIG. 11.

FIG. 14 shows an evaporator and condenser pan detail of the MDET of FIG. 11.

FIG. 15 shows an evaporator and condenser plate detail of the MDET of FIG. 11.

### DETAILED DESCRIPTION OF THE INVENTION

The phenomenon of cavitation and its use in heating liquids, including lipid emulsion liquids, is well known in the prior art.

Cavitational vacuum bubbles are created in the lower pressure parts of the lipid emulsion liquids, primarily in areas where the lipid emulsion liquid flows at high speeds. The phenomenon is common in central pumps and in the proximity of ship propellers or lipid emulsion fluid turbines, and may extensively erode the rotating propellers and the surface of all materials affected.

The phenomenon is accompanied by vibration and knocking-like noise; it distorts the flow pattern, and reduces the efficiency of the associated engine. Irrespective of the material the propeller or turbine blade is made of, cavitation erodes the respective surfaces by literally eating away even the hardest alloys and creating tiny holes and cavities on the surface. The name of the phenomenon is of this origin, as cavitation means the creation of cavities. For the above reasons, cavitation is usually a phenomenon to be eliminated.

Cavitational vacuum bubbles are generally small, just a few millimeters in size, and the bubbles are generated by a sudden decrease in pressure in high-speed lipid emulsion liquid flows between the molecules of the lipid emulsion liquid. The bubbles crash when entering high-pressure areas, or explode and fill the space evenly with drops, if the pressure of high-pressure lipid emulsion liquids drops suddenly. Small cavities are created among the drops and drop molecules, creating literally vacuum bubbles. The subsequent crash of such vacuum bubbles is accompanied by a low crashing noise and light emission. The crashing of large quantities of lipid emulsion liquid molecules produces cracking, bouncing, and rumbling noise. When the bubbles crash, the energy stored, which is in the form of significant heat and light energy in the bubbles, is released. The energy spreads at various frequencies and is absorbed by neighboring molecules, thereby increasing their temperature. Put another way, the resulting gas reaches a state where the greater temperature and pressure of the saturated gas breaks the molecular adhesion and the bubbles suddenly will split. The resulting high temperature is absorbed by the surrounding lipid emulsion fluid molecules, thus heating the lipid emulsion fluid. The heat generated during the cavitation process is sufficient to eliminate any bacteria, viral, heavy metal, and other contamination from lipid emulsion fluid, thus provides an added benefit of sterilization of the fluid being treated using the cavitation apparatus.

As part of the invention, a multiple displacement evacuation tank (MDET) is placed downstream of the cavitation apparatus. This MDET is used to treat a mixture of the lipid emulsion and plant matter and produce a highly purified plant oil stream. The tank is utilized to separate contamination, oils, and lipid emulsion (sterilized or not sterilized) during the process. The lipid emulsion liquid from the cavitation apparatus can be mixed with the plant matter and continuously cycled through the cavitation equipment for heating purposes. A separate flow of the lipid emulsion plant matter mixture can be supplied to an inner chamber of the MDET for oil extraction of the plant matter. This flow is dispersed over internal tubes at a specific rate for evaporation of selected fluid from the lipid emulsion. A vacuum can be drawn on the internal tank to facilitate condensation rates and temperatures of any variety of fluids. Non-evaporated fluid flows to a lower section of tank where separation of oil occurs with the oil floating atop the lipid emulsion, the emulsion flowing to the lowest section of tank, while sedimentation of plant by-products is siphoned from bottom on this section of the tank. The remaining lipid emulsion is reintroduced to the cavitation process with additional plant product for processing. In an alternative, the heated output of the cavitation apparatus can be used in one stream to heat the MDET and another stream of the heated output would be mixed with the plant matter for producing a highly pure oil extract.

Again, the utilization of this phenomenon to heat lipid emulsion liquids has been known for years. However, producing cavitation to heat lipid emulsion liquids has been indirectly—e.g. by using rotating bodies run by electric engines—more expensive than heating sterilized lipid emulsion liquids by using electricity directly. On the other hand, the situation is different, if other economic power sources—e.g. turbine, petrol or diesel engine, etc.—are available anyway. By using such power sources, purified heated sterilized lipid emulsion liquids may be produced directly.

In systems such as shown in the Griggs and the Hirsh patents above, circulating a lipid emulsion fluid in a closed system at a select high speed and passing through a narrowing channel, the sterilized lipid emulsion fluid is suddenly introduced into an expanding section (cavitation bores) and the necessary decompression to create cavitation occurs.

Cavitation is generally a detrimental phenomenon due to its destructive characteristics, excessive heat generation, high discharge pressure, and noise. However, an improved cavitational apparatus can be made by installing a constriction or interference between a rotating cavitational body and the internal surface of a housing containing the body and, optionally, the internal surface of the rotating cavitational body and a secondary and stationary rotor head. In this case, it is ensured that the vacuum bubbles are continuously exploded. By designing the internal of the housing with the interference or constriction, the lipid emulsion liquid to be heated surrounds the vacuum bubbles in the bores upon explosion, cavitational noise can be reduced, and the harmful effects of cavitation can be reduced or eliminated.

The invention, in one aspect uses cavitation apparatus producing heated purified sterilized lipid emulsion liquids, containing at least one engine, a housing, the lipid emulsion liquid to be heated, a rotating cavitation body rotating in the lipid emulsion liquid to be heated driven by the engine, a strainer enclosure, and a multiple displacement evacuation tank. The engine may be an electric engine, but steam or internal combustion engines, or the rotating shafts of turbines may also be used to drive the cavitation equipment. A stationary rotor head can be placed inside of the rotating cavitation body to form a second lipid emulsion liquid heating zone.

The advantages are amplified by having cavitation bores in the rotating cavitational body and the rotor head, if present. For the rotating cavitational body, its external surface is fined with cavitational bores, much like found in the Griggs patents. The bores and the chamber between the rotating cavitational body and the surrounding housing forms a cavitational flow zone. In the embodiment using the stationary rotor head, the external surface of the rotor head is also fitted with cavitation bores so as to face an inner surface of the rotating cavitational body, which is then generally ring-shaped. This creates an additional lipid emulsion liquid cavitational flow zone between the inside of the rotating cavitational body and the rotor head to enhance the cavitation of the lipid emulsion fluid and thereby alloying extraction of oil from raw plants as described in more detail below.

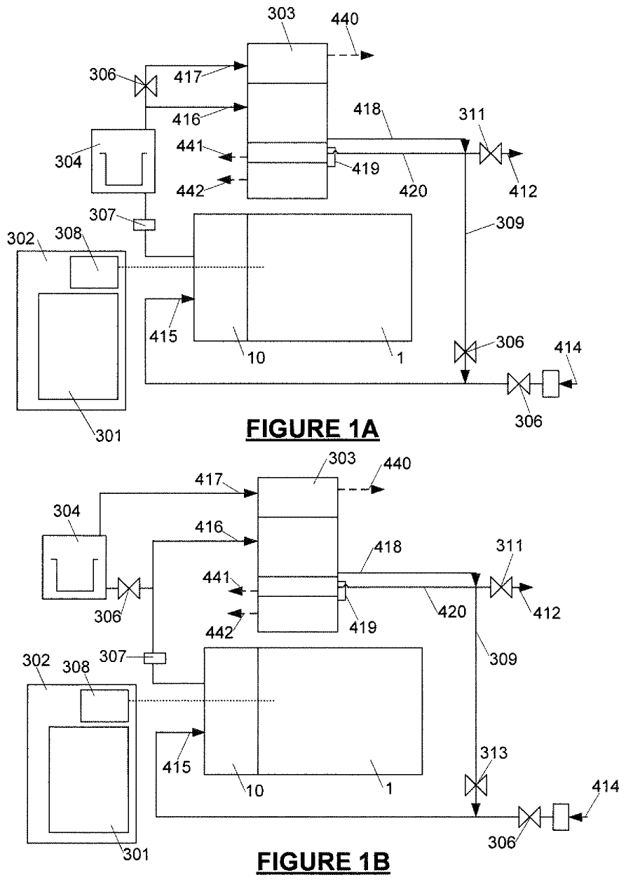

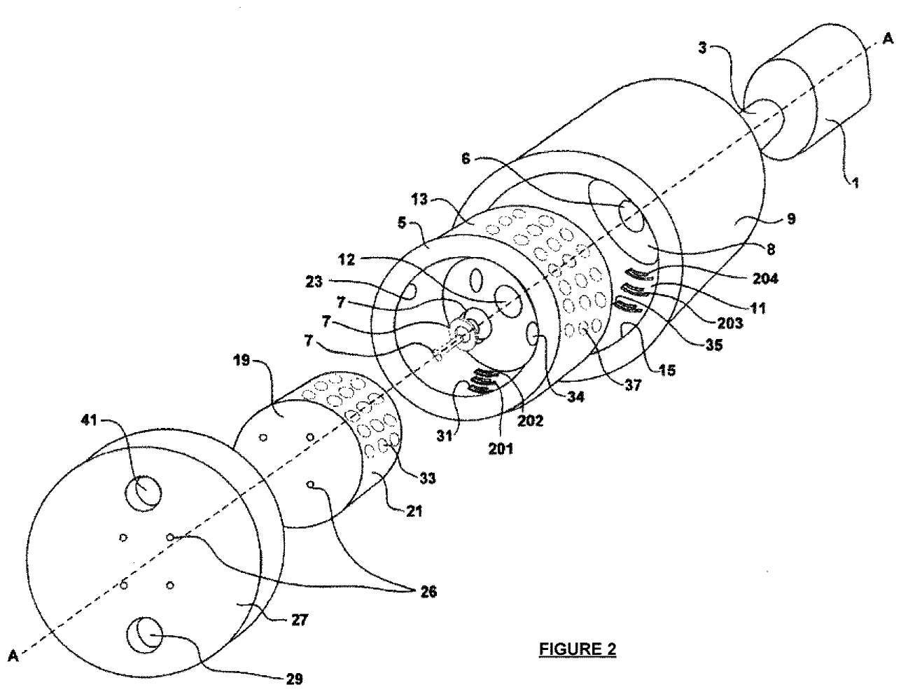

One embodiment of the system is shown in FIG. 1A. The system is configured with an external motor 1 for driving the cavitation equipment 10, a suitable strainer enclosure 304, a multiple displacement evacuation tank (MDET) 303, a variable speed controller 301, and a system controller 308 within an enclosure 302.

Lipid emulsion liquids 414 are introduced through a typical flow valve 306 being controlled by the system controller 308. Mixing with the return process fluid 308, the mixture 415 is delivered to the cavitation head 10 when the external motor 1 is driven by controller upon demand. The return process fluid 308 is the lipid emulsion supplied to the MDET for heating purposes.

Cavitated effluent is presented to the strainer enclosure 304 and dispersed over and through the plant materials (processed or unprocessed), while maintain both system hammer pressure and volume control with flow valve 306. Incoming fluid is monitored by a temperature probe 307 as it is delivered to the multiple displacement evacuation tank 303, this effluent as one stream 416 is used for heating chamber 609 within the multiple displacement evacuation tank 303. A second stream 417 is used for plant oil processing through another flow valve 306 as programmed in the system controller 308.

In another embodiment and referring to FIG. 1B, the sterilized lipid emulsion is split into two streams with one going to the strainer enclosure 304 for processing in the tank 303 as stream 417. The second stream 416 goes to the tank 303 for heating and recycling.

Multiple discharge ports of the displacement evacuation tank 303 provide evaporated and condensed fluid 440, sedimentary discharge 441, plant oil 442, and returned lipid emulsion liquids 420. The lipid emulsion liquids 418 used for heating the tank are also returned with the stream 420 for recycling to the cavitation apparatus 10. The combined lipid emulsion liquids 309 are introduced back to the input of system through a flow valve 313. A draining flow valve 311 is placed within this return line for draining fluid 412 as required.

The cavitation head is shown in the FIG. 2. The apparatus is designated by the reference numeral 10 and includes an external motor 1, that is used to rotate a rotating cavitational body or external rotor 5 through a direct drive shaft 3 that includes a shaft seal 7. The shaft 3 extends through an opening 6 in an end 8 of a housing 9 and an opening 12 in the external rotor 5. The external rotor 5 can be rotated at any number of speeds and this depends on the viscosity of the lipid emulsion fluid being heated. Typical speeds are from 2500-4000 rpm to generate optimal cavitation of lipid emulsion fluid, such speeds similar to those disclosed in the Griggs patents. However, to improve on Griggs patent, and to precisely locate, in the third dimension, the cavitation bubbles discharged to the cavitation bores 33, 37 the motor speed is tuned to the apparatus 10 by use of a variable speed controller 301 along with the directional and bounce bumpers. This is crucial to producing the exact shaft speed Sv, that determines horizontal V_{X}, vertical V_{Y}, and tertiary velocity V_{Z} of the lipid emulsion fluid at discharge zones 31, 35 of apparatus 10. The lipid emulsion fluid is compressed within the discharge funnel, directed, and released at a specific velocity Fv which is determined by the physical arc length L_{A} between cavitation zones (FIG. 7) in determining the actual number of cavitation discharge zones with a given cavitation head at any particular motor speed. Since the velocity of the sterilized lipid emulsion fluid F_{V} can be tuned, a determination of the time a lipid emulsion fluid molecule will take to travel along path L_{A} can be made and the horizontal and vertical component of the lipid emulsion fluid at discharge zones 31, 35 can be calculated. The curvilinear motion horizontal velocity is determined as a function, Vₓ=dₓ/dₜ, while the vertical velocity is V_{y} d_{y}/dₜ and tertiary velocity is V_{z}=d_{z}/dₜ. The directional and bounce bumpers are designed to drive the tertiary velocity V_{z} to zero, by eliminating the dz component and thus by solving for dₓ and d_{y}, the location of the cavitation bores 33, 37 and the distance between the bores B_{A} with respect to time (i.e. motor speed) for tuning can be determined. FIG. 7 only depicts two cavitation bores but it should be understood that the cavitation bores would extend along the circumference of the external rotor as shown in FIG. 7

A rotor housing 9 is provided that has no internal bearings. The existence of internal bearings is a critical failure mode of the Fabian patent as in this design, the bearings would be directly affected by thermal transfer of lipid emulsion fluid to bearings during the cavitation process. Accordingly, the shaft 3 of the motor 1 extends through the housing 9 and supports the external rotor 5 for rotation in a cantilevered configuration. The motor has a longer shaft 3 than normal and internal bearings in the motor to support the balanced external rotor 5 when the shaft 3 extends through housing 9. The housing 9 forms a cavity 11, with the cavity shaped to receive the external rotor 5. A conventional shaft seal (not shown) is positioned between the motor shaft 3 and the housing 9 for sealing purposes. With the cantilevered arrangement of the motor shaft and the bearings being associated with the motor for shaft support, the problems with bearing failure in the prior art devices is eliminated.

In operation, lipid emulsion fluid is introduced into the cavity 11 at a rate based upon optimal tuned speed of motor for the lipid emulsion fluid during operation of the apparatus 10. When the external rotor 5 is positioned within the housing, an outer surface 13 of the external rotor 5 faces an inner surface 15 of the housing 9. A gap 17 exists between these two surfaces 13 and 15, and this gap 17 becomes one lipid emulsion fluid heating zone for the apparatus 10, consisting of three lateral cavitation zones 215.

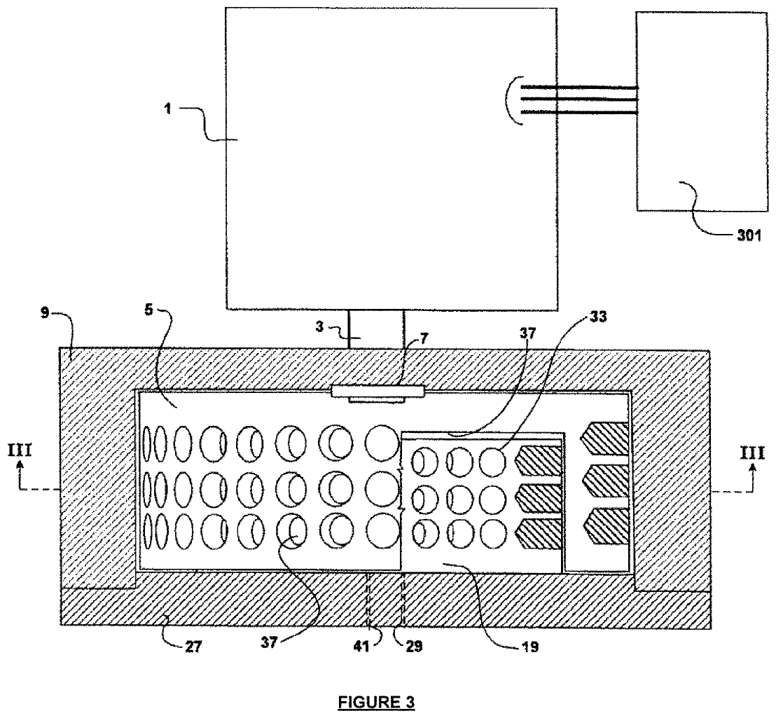

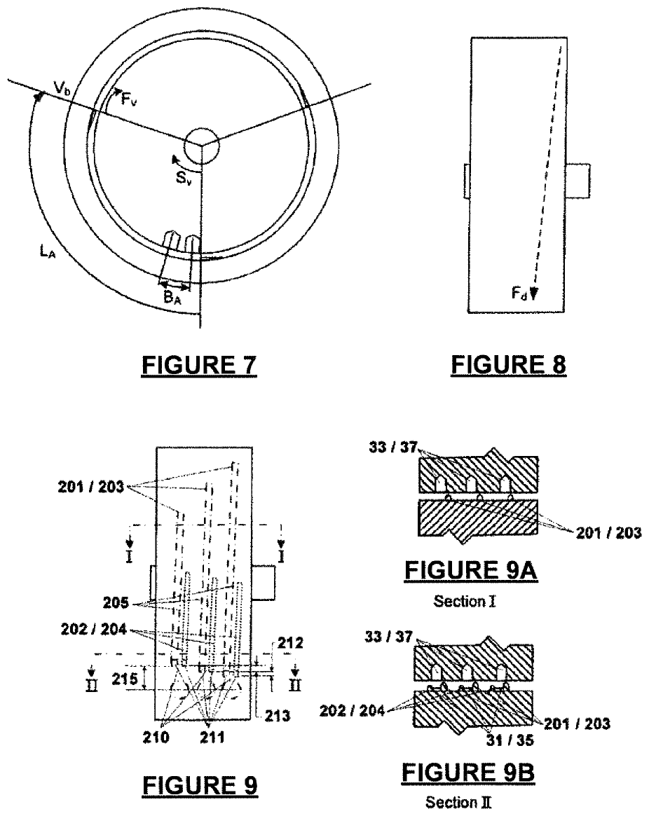

In the embodiment of FIGS. 2-10, six lipid emulsion fluid heating zones exist by reason of three sets of three discharge zones 31 and 35 for heating zone 17 and the same arrangement for heating zone 25, so that there are a total of eighteen cavitation zones 215. This number can be increased or decreased by varying the size of the cavitation head for additional arc length L_{A} consistent with the motor speeds selected. This is accomplished by providing a secondary rotor head 19 in a specific rotational pitch or configuration and has similar physical characteristics as the external rotor 5 to enhance the energy in the sterilized lipid emulsion fluid. An outer surface 21 of the rotor head 19 faces an inner surface 23 of the external rotor 5, with a gap existing therebetween. The gap forms another lipid emulsion fluid heating zone 25 of the apparatus 10.

A housing cover 27 is also provided. The housing cover 27 mates with the housing 9 using any known fastening technique to form a sealed cavitation chamber that includes the rotor head 19 and the external rotor 5. The rotor head 19 is mounted to the housing cover 27 in any conventional way to create the gap 25 as the second lipid emulsion fluid heating zone between the external or outer surface 21 of the rotor head 19 and the inner surface 23 of the external rotor 5. As an example of the mounting, openings 26 can be used with the appropriate fasteners.

The materials selected for the external rotor 5 and rotor head 19, and housing 9 and cover 27 are selected for optimal performance and safety. Examples of materials for the housing 9 and cover 27 include polymers, e.g., a polyimide. The external rotor 5 and rotor head 19 can be made from metal materials like aluminum or an alloy thereof or stainless steels.

The lipid emulsion fluid to be heated or purified is introduced to the cavitation apparatus 10 through an intake port 29 located on the housing cover 27. While the position of the intake port 29 can vary, it is preferred to be positioned so that lipid emulsion fluid entering the second sterilized lipid emulsion fluid heating zone 25, see FIG. 5 that is between the fixed internal rotor head 19 and the external rotor 5.

The cavitation zones 17 and 25 have special characteristics that allow for optimal cavitation to occur. FIG. 5 shows the location of these characteristics. Inner surface 15 of rotor housing 9, and inner surface 23 of external rotor 5 have directional bumpers 201 and 203, and bounce bumpers 202 and 204, respectively, to channel the lipid emulsion fluid on the direction path to ramp section 31 and 35 in each of these. The directional bumpers 201 and 203 of these surfaces are longer, while the bounce bumpers 202 and 204 are shorter in length and allow the lipid emulsion fluid to be channeled to the ramp zone 31 and 35, along the natural lipid emulsion fluid direction Fa as depicted in the tertiary view of FIG. 8. Each set of these bumpers is offset with the inner series to midrange series being offset 212, while the midrange series to outer series offset 213 to accommodate the variation of time for lipid emulsion fluid molecule to travel in a cylindrical motion, and thus effect the cavitation zone velocity components V_{X}, V_{Y}, and V_{Z} in determining cavitation bore 33 and 37 locations. This allows the internal rotor 21 and external rotor 5 to be consistent with standard manufacturing processes.

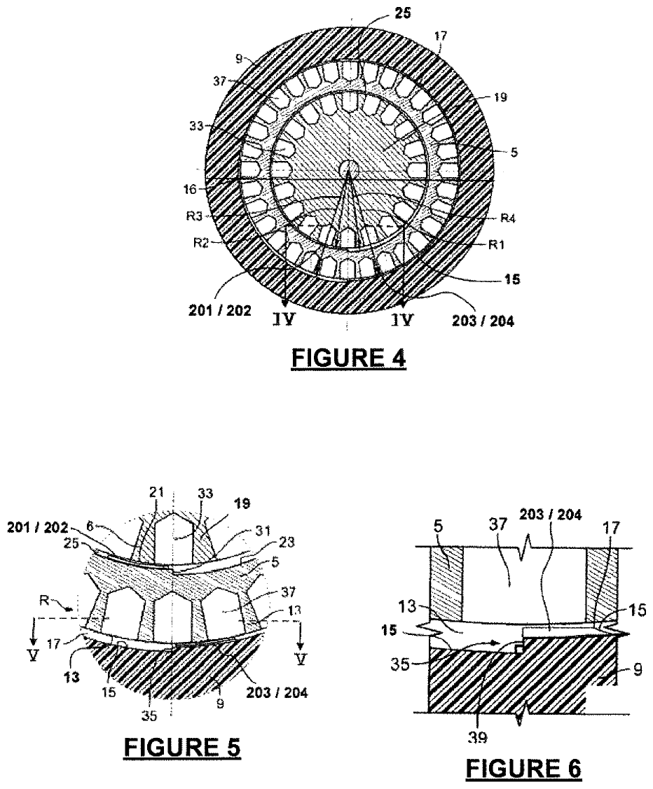

Additionally, allowing the discharged lipid emulsion fluid path to be three dimensional presents geometric manufacturing issues with locating and forming the cavitational bores 33 and 37, a perpendicular section 210 of directional bumpers 201 and 203 and bounce bumpers 202 and 204 to facilitate a two dimensional discharge of lipid emulsion fluids to the cavitation bores 33 and 37 is provided. The cavitation bores 33 and 37 are located in the two dimensional plane, because the tertiary velocity V_{z} has been driven to zero, such that distance between discharge zone 215 and cavitation bores 33, 37 is in direct correlation to speed of lipid emulsion fluid Fᵥ. By precisely locating the discharge lipid emulsion fluid to the alignment of the cavitation bores 33 and 37, the destructive cavitation bubbles are prevented from being released uncontrollably in sections without cavitation bores. This is accomplished by the shape of the inner surface 23 of the external rotor 5 in the funnel zones 205 between directional bumpers 201 and bounce bumpers 202. This ramped surface has a spiral shape, which is illustrated by radial distances, as measured from a central and longitudinal axis A of the apparatus 10. Referring to FIG. 4, one radius R3 as measured from a center axial point of the apparatus is such that the radius R3 is less than another radius R4. This difference in radius and spiral shape of the inner surface 23 of the external rotor 5 creates a wave ramp 31. This configuration produces a pressure differential critical for formation of cavitation vacuum bubbles at wave ramp 31.

The rotor head outer surface 21 is configured with a number of spaced apart cavitation bores 33 of a given depth and circumference. The bores 33 cooperate with the wave ramp 31 and spiral shape of the inner surface 23 of the external rotor 5 to create a continuous and growing vacuum bubble generation in the regular arrangement of the cavitation bores 33 of the rotor head 19. Heat is generated through the cavitation process of the lipid emulsion fluid with virtually no destructive impact to the rotor head 19 or the cavitation bores 33. During operation, the external rotor 5 is spinning in a clockwise direction, see FIG. 2. The lipid emulsion fluid is compressed during the rotation cycle of the external rotor 5 and pressure increases in the lipid emulsion fluid cavitation zone 25 and 17. The entry to the wave ramps 31 and 35 provides an area of expansion that generates a rapid loss of pressure and this pressure reduction permits the forming of the cavitation bubbles and subsequent explosion in the cavitation bores 33 and 37.

After entering the zone 25, the lipid emulsion fluid exits the zone 25 through multiple ports 34 at the rear face 36 of the external rotor 5. This exiting lipid emulsion fluid then enters the other lipid emulsion fluid cavitation zone 17 formed in the space between the inside surface 15 of the housing 1 and the outer surface 13 of the external rotor 5. In effect, the lipid emulsion fluid is introduced to a secondary cavitation process, which is opposite in direction from a spinning lipid emulsion fluid flow direction to the first cavitation process occurring in the zone 25 between the rotor head outer surface 21 and the inner surface 23 of the external rotor 5.

The housing 27 is equipped with the similar spiral configuration on the inner surface 15 thereof with a corresponding wave ramp 35 formed by the radial differences shown in FIG. 6. That is, the radius R1 is less than radius R3 so as to form the wave ramp 35 in the funnel zones 205 between directional bumpers 203 and bounce bumpers 204.

The external rotor 5 includes cavitation bores 37, like those in the rotor head 19. Lipid emulsion fluid exiting the first heating zone 25 is introduced into the second heating or cavitation zone 17. The spinning lipid emulsion fluid therein is then introduced into the regular arrangement of external rotor cavitation bores 37 in the same fashion as lipid emulsion fluid is introduced into the bores 33 in the rotor head 19. What is different between chambers 17 and 25 is the orientation of the wave ramps 31 and 35. The wave ramp 35 is configured oppositely from the wave ramp 31.

Put another way and referring to FIG. 5, the spiral of increasing radius moves in the clockwise direction for surface 23 of the external rotor 5, short radius R3 to longer radius R4. For surface 15 of the housing 9, the increasing radius moves in the counterclockwise direct, short radius R1 to longer radius R2. This means that the faces of the wave ramps 31 and 35 are opposite to each other. Referring to FIG. 6, the wave ramp 35 has face 39, which is shown with a right angle configuration. However, the face 39 could be angled as well. The spiral configuration insures the maximum vacuum bubble generation and the resulting heat generation bubble explosion. The dual balanced cavitation process of the zone 17 and zone 25 occur simultaneously. Thus, through a single rotational cycle of the motor and external rotor 5, the lipid emulsion fluid is processed twice for cavitation.

It is also desirable for the cavitation heating process that the primary wave ramps 31 and 35 be aligned at rest as shown in FIG. 7. That is, the wave ramps 31 and 35 are at the 6 o'clock position. Since the housing 9 is fixed and the apparatus would be positioned so that the axis A is horizontal, it is not a problem to have the wave ramp 35 in this position. In order to have the wave ramp 31 of the external rotor 5, which can move due to its motor connection in this position, one way is to have the external rotor 5 balanced by the multiple outlet ports 34 such that the when motor 1 is not providing power, the external rotor 5 returns to the proper start up position in respect to the inner wave ramp 31 and the outer wave ramp 35. With this start up position, maximum heat generation of the lipid emulsion fluid within the process is achieved. While the wave ramp position of the external rotor could vary from the 6 o'clock position, even as high as 90 degrees to either side, cavitation efficiency is lowered when varying from the preferable start up position. It is also preferred that the wave ramps 31 and 35 be at the 6 o'clock position as this facilitates the startup of the apparatus from a priming standpoint (the input 29 is aligned with the wave ramp 31 since the apparatus not only functions as a lipid emulsion liquid cavitation device but also like a pump, drawing the lipid emulsion liquid in to the apparatus 10 and discharging it. Varying from the 6 o'clock position towards either the 3 or the 9 o'clock reduces the pressure drop at the ramp and/or reduces the cavitation. By changing this configuration of the cavitation zones 215 to alternative positions such as the 3 or 9 o'clock positions, in conjunction with varying the arc length L_{A}, the cavitation device absorbed the heat of the lipid emulsion fluid and produced a cooling effect, while maintaining the non-destructive nature of the cavitation device.

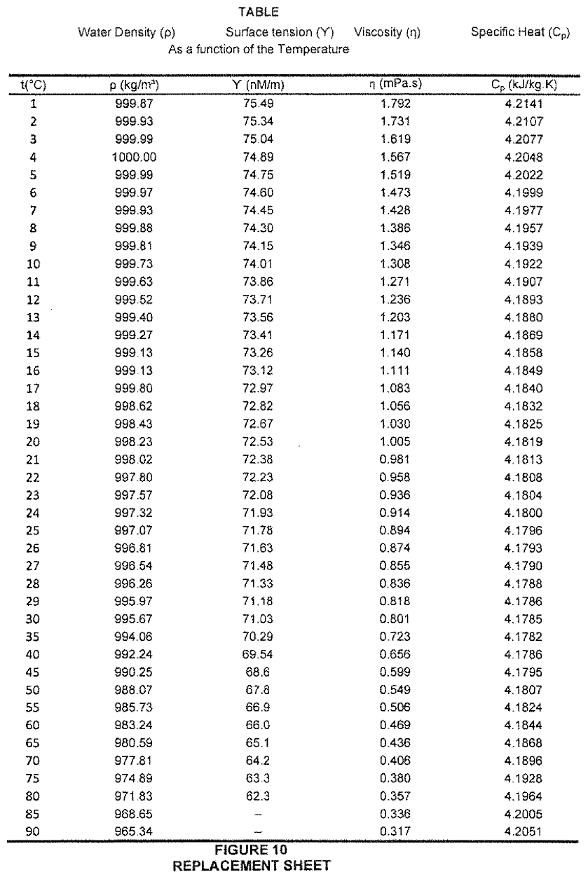

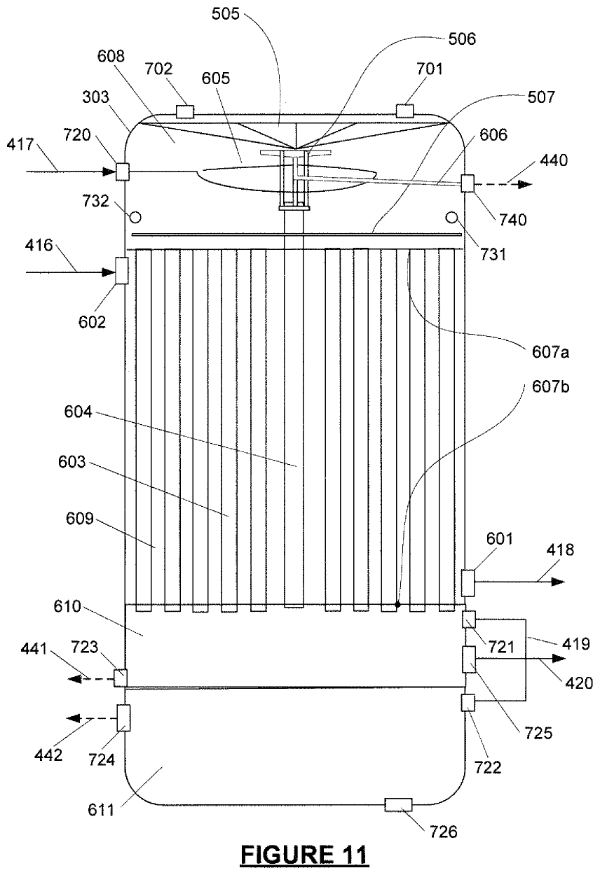

The sterilized lipid emulsion fluid being cavitated then leaves the cavitation apparatus 10 through an outlet port 41 in the cover 9 at low pressure (<1 atmosphere). In order achieve maximum efficiency and eliminate the destructive element of cavitation, a total system should include the variable speed motor controller 301, a system controller 308, a strainer enclosure 304, which acts as a fluid hammer tank, storage, and mixing tank, and a multiple displacement evacuation tank 303 as a minimum. The strainer enclosure is meant to be multipurpose, plant & fluid mixing, pressurized hammer tank, and storage for system as the density and temperature of fluid will be changing constantly. Strainer enclosure 304 is set to 12-15 psi which ensures proper noise control of heating lipid emulsion fluid, while also allowing for the cavitation apparatus 10 to operate at an ambient lipid emulsion fluid flow. Because each lipid emulsion fluid's physical properties vary with respect to temperature rise, as indicated in the chart of FIG. 10 for lipid emulsion fluid, it is important for the motor speed to be continually adjusted for speed control to insure cavitation process; specifically the distance for discharge zone 215 to cavitation bores 33, 37 is controlled. By tuning the motor speed to the physical characteristics of the lipid emulsion fluid at any given temperature or other variant, it ensures the distance to cavitation bores 33, 37 from funnel zones 205 is maintained for non-destructive cavitation. An additional control panel 302 will ensure optimization of the cavitation process for the lipid emulsion fluid under process by monitoring lipid emulsion fluid temperature at probes 307 of intake and output of cavitation apparatus 10. Also, control valves 306 may be deployed with a crossover 308 to enhance system performance for certain applications such as purification.

The invention is based on the realization that the objective of having a cavitation lipid emulsion fluid heating apparatus without the known problems in prior art cavitation heating apparatus can be obtained by having a constricting form or interference in the zones or chambers 17 and 25 containing the wave ramp 35, directional bumpers 203, and bounce bumpers 204 between the rotating external rotor outer surface 13 and the inner surface 15 of the housing 9 and same constriction or interference as wave ramp 31, directional bumpers 201, and bounce bumpers 202 between the rotor head outer surface 21 and the external rotor inner surface 23. By designing the internal surface 15 of the housing 1 and the internal surface 23 of the external rotor 5 this way, it can be continuously ensured that the vacuum bubbles explode. Ensuring by designing the spiral surfaces 15 and 23, directional bumpers 201 and 203, and bounce bumpers 202 and 204 that funnel the lipid emulsion liquid to be heated surrounds the vacuum bubbles in the bores upon explosion, cavitational noise is reduced, as well as reducing or eliminating the other harmful effects of cavitation, e.g., erosion of component parts and the like.

In significant variation to the Fabian design, it should be understood that the two chamber or zone design of FIGS. 2-9 can be modified so that it is only a one chamber design and still function with all benefits with a single drive motor. Thus, the rotor head 6 could be made without the cavitation bores and act only as a conduit to feed lipid emulsion liquid to the zone 17 between the housing 1 and the external rotor 5. In yet a further embodiment, the rotor head 6 could be eliminated so that only the external rotor 5 with its cavitation bores 37, the housing 9 with its specially configured inner surface 15, and the appropriate inlet and outlet ports would interact to heat the lipid emulsion fluid. This adaption of the invention allows for multiple size application configurations, with various motor sizes adaptable to a cavitation apparatus 10 for energy efficiency specific to the desired application.

While a single chamber apparatus provides heated sterilized lipid emulsion liquid without many of the cavitation-related problems of prior art devices, it is more advantageous to employ the embodiment of FIGS. 2-9, wherein the external rotor is installed with a fixed rotor head 19, the external surface of which is fitted with additional cavitational bores 33. Together this configuration, with the associated system components, allows the rotor pump to produce heat energy at a significant increased ratio of energy utilization to consumption, while overcoming the traditional problems of prior systems; such as sonic sound waves (noise), bearing failures, and high discharge pressure energy losses.

One embodiment of the invention is directed at releasing heat energy for use in delivering a sterilized lipid emulsion fluid for fluid purification and separation, and any lipid emulsion fluid processing that require heat to complete progression. Moreover, the invention, releases the energy through a cavitation process using less power consumption then traditional systems and significantly improves the energy and installation cost of purification system with similar capabilities. The balanced internal fixed rotor 19, external rotor 5, wave ramps 31 and 35, directional bumpers 201 and 203, and bounce bumpers 202 and 204, and coinciding housing 1 and cover 27 provide the unique physical characteristics to produce heat at an increased rate of return of energy consumption while maintaining thermal characteristics.

The present invention comprises these unique component characteristics in a manner such that the lipid emulsion fluid that supplies the heat for oil extraction from plant materials has its heat retained for extended periods of time and thus requires lower cycles of energy consumption when using this material for oil extraction. Any plant materials that would have desirable oils for extraction can be used in the invention and a more detailed description is provided below. One example would be hemp plant material so that cannabidiol (CBD) could be extracted therefrom.

The present invention is unique such that the multistage cavitation process is initially completed through a primary cavitation rotor head that is stationary, with the external rotor acting as both a centrifugal source for the initial process and a cavitation element of the second stage. Both the external rotor and rotor housing have wave ramps to enhance the cavitation process. This allows the system to maximize the energy released from the cavitation process, while maintaining a low discharge pressure in so that energy is not lost by changing the state of the lipid emulsion fluid to a gas. The present invention configuration is such that the normally associated noise from the cavitation process is minimized and controlled.

As explained above, the spiral configuration of the surfaces 15 and 23 with the directional bumpers 201 and 203, and bounce bumpers 202 and 204 are an important feature of the invention. This configuration allows for the creation and growth of the vacuum bubbles in the bores 33 and 37. In the bores 33 and 37, the vacuum bubbles are created among the molecules and surrounded by lipid emulsion fluid to be heated. The bubbles do not actually explode but crash, when they reach the cavitation bores 33 and 37.

According to the method, the external rotor 5 is placed into the housing 1 and is rotated with the driving engine 1. During rotation, lipid emulsion fluid to be heated is injected into the housing 1 through the input 29. With the help of the rotation, continuously growing vacuum bubbles are created among the lipid emulsion liquid molecules in the bores 33 of the rotor head 6, if present, and in the bores 37 of the external rotor 5. Once the vacuum bubble reaches the cavitation step 31 or 35, they crash. The lipid emulsion fluid to be heated is otherwise continuously flowed through the chambers 25 and 17, with the vacuum bubbles crashing in the expanding lipid emulsion liquid after passing through the funnel zones 205. Upon the crash, the lipid emulsion liquid molecules, moving in opposite directions, explode. The heat generated during the explosion is absorbed by the surrounding lipid emulsion liquid, and the heated sterilized lipid emulsion liquid is ultimately extracted through the output 41.

It is the advantage of the cavitation apparatus to successfully eliminate or reduce the harmful effects of the cavitation phenomenon by using flow channels designed for the lipid emulsion liquid to be heated and by using the procedure for the operation of the equipment.

Turning back to the embodiments discussed above, one embodiment of the invention uses a single rotating cavitation body having bores in it, with the bores open to an outer surface of the cavitation body. This cavitation body rotates within a housing and interacts with the cavitation step, which is located on the inside surface of the housing. During this rotation, vacuum bubbles are created in the bores in the rotating body. The bubbles eventually grow such that they are no longer confined to the bores and crash into the cavitation step. This crash causes the lipid emulsion liquid molecules to explode, which is the energy release that causes the heating of the lipid emulsion fluid.

In another embodiment, there are two sets of bores, one on the outer surface of the rotating body and another set of bores on the outer surface of a second and stationary component located within the rotating body. In this dual bore embodiment, the cavitation step or wave form for the bores on the outer surface of the rotating body is on the inner surface of the housing. The cavitation step for the bores on the outer surface of the stationary rotor head are on the inner surface of the rotating body.

The inventive system configuration allows the cavitation apparatus to produce heat energy at a significant increased ratio of energy utilization to consumption, while overcoming the traditional problems of prior systems; such as sonic sound waves (noise), bearing failures, and high discharge pressure energy losses. The system consisting of control panel 302, variable speed motor controller 301, system controller 308, strainer enclosure 304, multiple displacement evacuation tank 303, and control valves 306 with crossover 308 enhance the capabilities of the cavitation apparatus 10.

The present invention, through mechanic means, produces heated sterilized lipid emulsion fluid at a 30-70% decreased rate of energy consumption (dependent upon the volume of sterilized lipid emulsion fluid in the system) through a balanced cavitation furnace.

The multiple displacement evacuation tank (MDET) 303 enhances the system performance by further purifying the sterilized lipid emulsion fluid while discharging plant oils without contamination.

FIG. 11 discloses the embodiment of the invention using the multiple displacement evacuation tank 303 of FIGS. 1A and 1B in more detail. This apparatus has four zones to facilitate the purification of the sterilized lipid emulsion fluid while separating the plant oils, sedimentary process discharge, and evaporation and condensation fluids.

The heated lipid emulsion fluid from the cavitation apparatus 10 is represented by the stream 416 and is delivered through port 602 to a sealed chamber 609 for heating thereof. Chamber 609 includes a plurality of tubes 603 that are designed for evaporation of an external fluid flowing through the tubes and a central evacuation tube 604 between a lower chamber 610, which is disposed beneath the chamber 609 and an upper chamber 608, which is disposed above the chamber 609. The heated lipid emulsion passing through the sealed chamber 609 is discharged through port 601 as stream 418 and returned to cavitation apparatus 10 as depicted in FIGS. 1A and 1B.

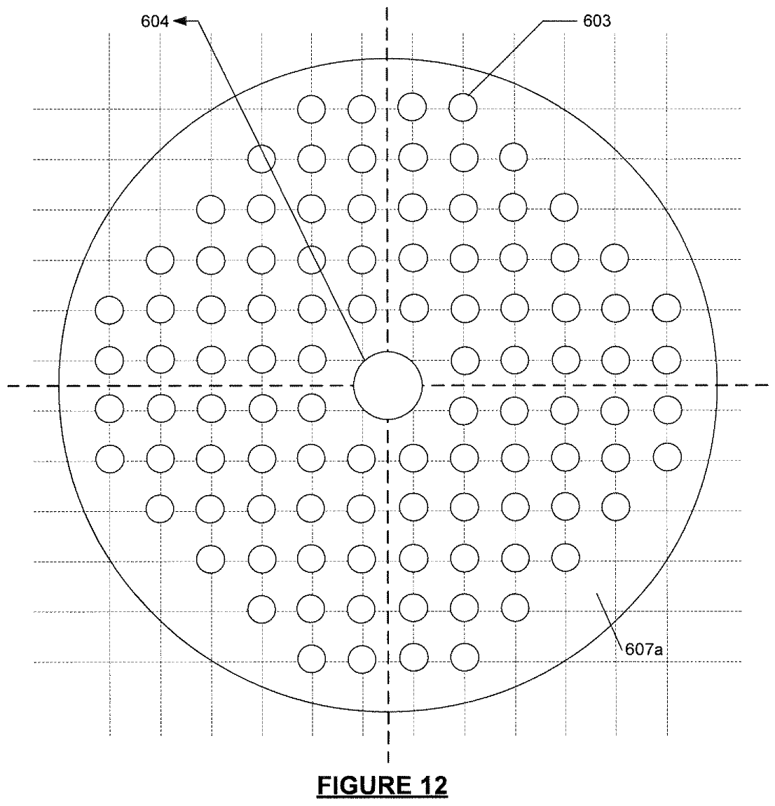

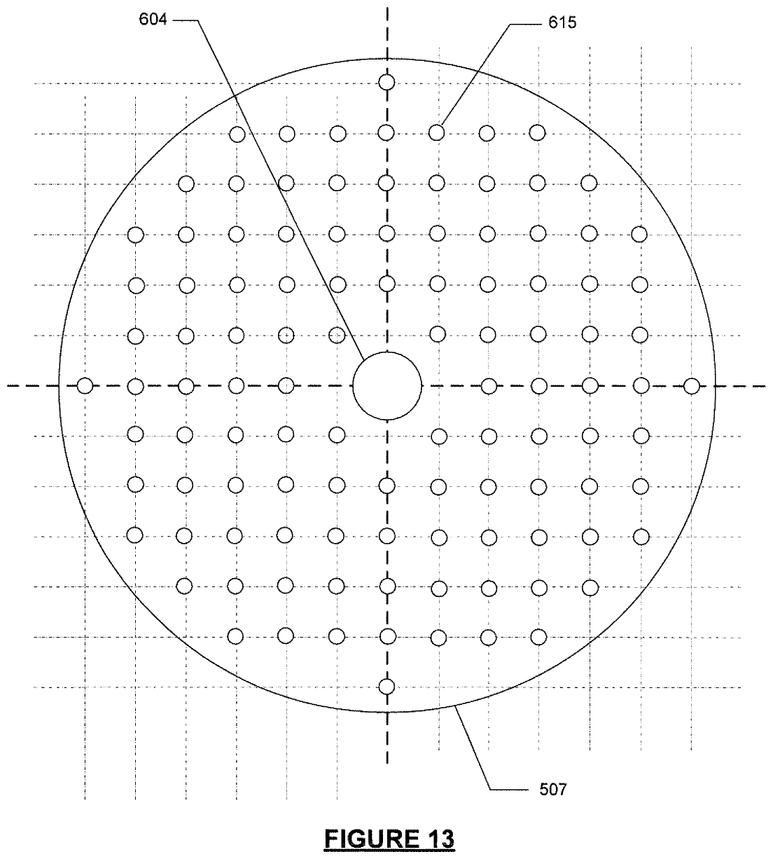

Additional separation and purification of the feed to the MDET occurs within the multiple displacement evacuation tank 303 when lipid emulsion fluid and plant oil mixture 417 is introduced to the upper chamber 608 of the multiple displacement evacuation tank 303 through port 720. This mixture is fed to a ring diffuser 605, wherein the ring diffuser has a number of openings (not shown). This fluid is dispersed by the diffuser 605 through the openings and directed to a secondary diffuser plate 507 as detailed in FIG. 13. The secondary diffuser plate 507 has a plurality of openings 615 to ensure that fluid is evenly dispersed to the upper plate 607a, detailed in FIG. 12, of the heating chamber 609. The fluid dispersed on the plate 607a flows evenly down the internal sides of the evaporation tubes 603 of the heating chamber 609. Fluid exits the evaporation tubes 603, which has another lower plate 607b identical to the upper plate 607a of heating chamber, and is accumulated in chamber 610. Any additional evaporation of this fluid can be evacuated through tube 604 back to the upper or evaporation and condensation chamber 608.

As this fluid volume increases in chamber 610, the plant oil is separated from the lipid emulsion fluid as well as the sedimentary contamination 441 by gravity. Sedimentary contamination 441 is discharged through port 723. The plant oil in chamber 61 is discharged as stream 419 through port 721 and accumulated, through port 722 into chamber 611. After further settlement occurs for the plant oil 419 in chamber 611, the remaining plant oil can be recovered through port 724 as pure plant oil 442. Port 725 allows for sterile lipid emulsion fluid in chamber 610 to be returned to system from chamber 610, see 420 in FIG. 1A, which can be mixed with makeup fluid 414. Port 726 serves as a drain port for chamber 611.

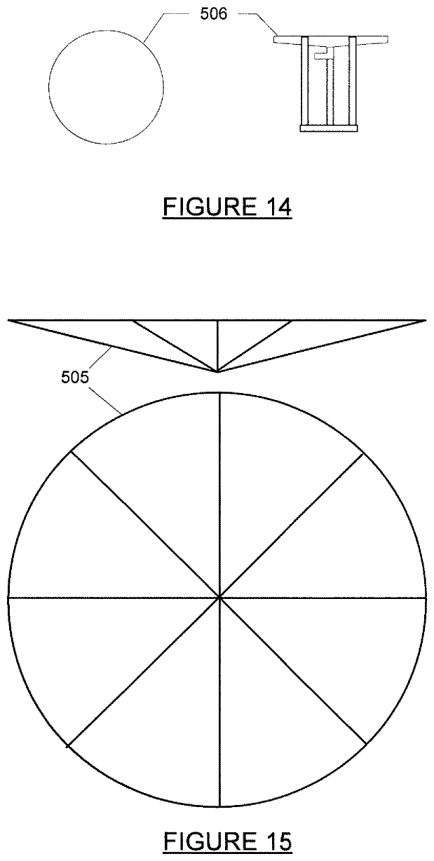

The upper evaporation and condensation chamber 608 also has a condensation plate 505, detailed in FIG. 15, and a condensation collection pan 506, detailed in FIG. 14. Both the plate 505 and pan 506 are supported by the central evacuation tube 604, which extends between the plates 607a and b and provides communication between chamber 610 and chamber 608. The chamber 608 allows for evacuation of evaporated fluid 440 through tube 606 and discharge port 740. More particularly, any fluid that is condensed using the plate 505 is collected in the pan 506, the pan bottom connected to tube 606.

Chamber 608 has ports 701 and 702 which allow for the introduction of compressed cold air or cold fluid into the chamber 608 to facilitate the evaporation & condensation process. Ports 731 and 732 are also provided to allow for the chamber to be under vacuum conditions if so desired.

Another aspect of the invention is the ability of the apparatus to increase the density of the lipid emulsion fluid being heated. Since it is known that less energy is needed to heat denser lipid emulsion fluid, the increase in density of the lipid emulsion fluid helps in increasing the efficiency of the lipid emulsion fluid heating process.

Testing has been performed to monitor the heating effect of the inventive apparatus. This testing involved running the cavitation apparatus using different volumes of lipid emulsion fluid to be heated and monitoring inlet lipid emulsion fluid temperature, the volume of lipid emulsion fluid flow rate, outlet lipid emulsion fluid temperature of the cavitation apparatus, the temperature of the supply lipid emulsion fluid to the apparatus, power of drive motor, electricity consumption, values of power, consumption of electricity power, and ambient temperature. This testing showed high efficiencies in terms of amount of heating done to the lipid emulsion fluid as compared to the power used to run the apparatus.

The lipid emulsion described above is one example of a feed for the cavitation apparatus and fluid for use in both heating the MDET and extracting oil from the plant matter being treated. Another example would be to start with a sterile lipid emulsion as the feed for the cavitation apparatus. Other fluids that could be used as a feed for the cavitation apparatus include water, including purified types such as distilled water, deionized water, water subjected to reverse osmosis. Moreover, the cavitation process is known to improve the purity of a fluid being treated and this purification aspect of the cavitation only helps when the output of the cavitation process is used with plant material to create a purer oil therefrom.

While hemp is a preferred plant matter material for use in the invention for oil extraction, virtually any plant matter can be used that would have a useful oil that could be extracted. Examples of plant oils include corn oil, grapeseed oil, olive oil, avocado seed oil, almond oil, palm kernel oil, pumpkin seed oil, rice bran oil, sesame seed oil, sunflower seed oil, soybean oil, flax seed oil, cocoa butter, coconut oil, peanut oil, and cottonseed oil. Plants producing essential oils like lavender, thyme, rose and the like are also candidates for the plant matter.

The plant matter is preferably shred or broken down so as to provide an increase in surface area for mixing with the output of the cavitation apparatus. However, the plant matter could also be use in its raw form as well. Hemp shredders are well known for conditioning hemp for hemp oil extraction so that a further discussion of these kinds of conditioning apparatus is not needed for understanding of this aspect of the invention.

The invention includes both the MDET and its combination with the disclosed cavitation apparatus and a method of treating plant matter using the heated fluid output from the cavitation apparatus and the MDET to extract a high quality and pure oil product for subsequent use as would be known in the art.

As such, an invention has been disclosed in terms of preferred embodiments thereof which fulfills each and every one of the objects of the present invention as set forth above and provides a new and improved lipid emulsion fluid heating apparatus using cavitation, particularly to extract and purify plant oils using the heated lipid emulsion fluid.

Of course, various changes, modifications and alterations from the teachings of the present invention may be contemplated by those skilled in the art without departing from the intended spirit and scope thereof. It is intended that the present invention only be limited by the terms of the appended claim.

1. A multiple displacement evacuation tank comprising:
a plurality of ports for inputs and outputs;
multiple chambers for evaporation, distillation, condensation, and sedimentation of a cavitated fluid for discharge, and
control points to manipulate the cavitated fluid passing through the multiple displacement evacuation tank for purification,
the multiple chambers further comprising:
an upper chamber that allows for condensation of cavitated fluids heated and discharge of condensed cavitated fluids;
a middle heating chamber that is used for heating fluid under purification for evaporation, the middle heating chamber also configured for extracting heat from the cavitated fluid flowing through the middle heating chamber; and
a lower chamber that collects fluid passing from the upper chamber and through the middle heating chamber, the lower chamber allowing for separation of fluid via mass weight through distillation and sedimentation, the lower chamber optionally providing a capability of outputting fluid from the lower chamber for recycle to the upper chamber.

2. A system for extracting oil from plant material comprising:
a) an apparatus for heating a fluid using cavitation, the apparatus comprising:
a housing having an inlet for fluid to be heated and an outlet to discharge the heated fluid from the housing;
an external rotor adapted to be fixed on a motor shaft extending in a axial direction, the external rotor contained in the housing and adapted to rotate within the housing, the external rotor having a plurality of cavitation bores arranged in an outer surface thereof and the external rotor arranged within the housing to form a fluid heating zone between the outer surface of the external rotor and an inner surface of the housing that faces the outer surface of the external rotor, the inner surface of the housing extending in the axial direction and a housing circumferential direction, wherein the inner surface of the housing facing the bore-containing outer surface of the external rotor has a plurality of first funnel zones extending along the inner surface of the housing and in the housing circumferential direction, the plurality of first funnel zones laterally spaced apart from each other in the axial direction, each first funnel zone terminating in a first discharge zone, each first funnel zone including a first ramp, each first discharge zone offset in the housing circumferential direction from an adjacent first discharge zone, fluid entering the housing being heated by interaction with the first funnel zones and first ramps, bores in the external rotor, and external rotor rotation; and
b) the multiple displacement evacuation tank of claim 1;
c) a strainer enclosure adapted to receive output from the cavitation apparatus and input of plant material so as to create a mixture of the fluid and plant material, the mixture is fed to the multiple displacement evacuation tank so that oils in the mixture can be recovered using the multiple displacement evacuation tank.

3. A method of recovering oil from plant material using a multiple displacement evacuation tank comprising the steps:
a) providing the multiple displacement evacuation tank of claim 1,
b) introducing a fluid into the upper chamber,
c) dispersing the fluid in a controlled manner to facilitate the evaporation, distillation, condensation, and sedimentation of the specific fluid and contamination by passing the fluid through the middle heating chamber,
d) discharging fluids and contamination from the fluid from the lower chamber including separating plant oil from contamination and fluid for recovery, and
e) recycling fluid from one or both of the lower chamber and middle heating chamber to the multiple displacement evacuation tank.

4. The method of claim 3, further comprising:
a) providing a cavitation apparatus comprising a) an apparatus for heating a fluid using cavitation, the apparatus comprising:
a housing having an inlet for fluid to be heated and an outlet to discharge the heated fluid from the housing;
an external rotor adapted to be fixed on a motor shaft extending in a axial direction, the external rotor contained in the housing and adapted to rotate within the housing, the external rotor having a plurality of cavitation bores arranged in an outer surface thereof and the external rotor arranged within the housing to form a fluid heating zone between the outer surface of the external rotor and an inner surface of the housing that faces the outer surface of the external rotor, the inner surface of the housing extending in the axial direction and a housing circumferential direction, wherein the inner surface of the housing facing the bore-containing outer surface of the external rotor has a plurality of first funnel zones extending along the inner surface of the housing and in the housing circumferential direction, the plurality of first funnel zones laterally spaced apart from each other in the axial direction, each first funnel zone terminating in a first discharge zone, each first funnel zone including a first ramp, each first discharge zone offset in the housing circumferential direction from an adjacent first discharge zone, fluid entering the housing being heated by interaction with the first funnel zones and first ramps, bores in the external rotor, and external rotor rotation;
b) supplying fluid to the cavitation apparatus for heating to produce a heated fluid;
c) using the heated fluid to mix with plant material and create a heated fluid-plant material mixture for introduction into the upper chamber, and supplying one of the heated fluid or the heated fluid plant material mixture to the middle heating chamber for heating of the heated fluid-plant mixture introduced into the upper chamber,
d) recovering plant oil from the plant material, contamination, and heated fluid, the heated fluid optionally recycled to the cavitation apparatus along with discharge from the middle heating chamber.

5. The method of claim 3, wherein the fluid is water, a lipid emulsion, or a sterilized lipid emulsion, the plant material is hemp, and the plant oil is a cannabinoid.

6. The method of claim 4, wherein the fluid is water, a lipid emulsion, or a sterilized lipid emulsion, the plant material is hemp, and the plant oil is a cannabinoid.

7. The tank of claim 1, wherein the middle heating chamber further comprises a sealed chamber having a plurality of tubes positioned in a space formed by the sealed chamber, the sealed chamber having a first inlet and first outlet for the space, each of the tubes having an inlet in communication with the upper chamber and configured to received fluid from the upper chamber and an outlet in communication with the lower chamber to supply fluid to the lower chamber, heated fluid supplied to the space heating fluid passing through the plurality of tubes.

8. The tank of claim 1, wherein the upper chamber further comprises:
a first diffuser configured to disperse fluid entering the upper chamber,
a second diffuser configured to disperse fluid in the upper chamber for entering the middle heating chamber; and
a condensation plate and condensation collection pan positioned above the first diffuser, the condensation collection pan in communication with an evaporation tube passing through the middle heating chamber, the upper chamber having an outlet in communication with the condensation collection pan, evaporated fluid passing through the evaporation tube from the middle heating chamber condensing on the condensation plate and collected on the condensation collection pan for discharge through the outlet in the upper chamber.

9. The tank of claim 8, wherein the upper chamber includes one or more ports for introduction of cold fluid and/or compressed air to facilitate evaporation and condensation and/or for evacuation of the upper chamber.

10. The tank of claim 1, wherein the lower chamber further comprises:
a first chamber in communication with the middle heating chamber having at least one outlet, and
a second chamber in communication with the first chamber and having at least one outlet,
the first chamber allowing for sedimentation of fluid from the middle heating chamber to separate plant oil from the fluid received from the middle heating chamber, the first outlet positioned in the first chamber to direct plant oil to the second chamber for recovery via the at least one outlet in the second chamber.

11. The tank of claim 10, wherein the first chamber has an additional outlet to recycle fluid from the middle heating chamber or recover the fluid from the middle heating chamber or discharge sedimentary contamination from the first chamber.

12. The tank of claim 7, wherein the upper chamber further comprises:
a first diffuser configured to disperse fluid entering the upper chamber,
a second diffuser configured to disperse fluid in the upper chamber for entering the middle heating chamber; and
a condensation plate and condensation collection pan positioned above the first diffuser, the condensation collection pan in communication with an evaporation tube passing through the middle heating chamber, the upper chamber having an outlet in communication with the condensation collection pan, evaporated fluid passing through the evaporation tube from the middle heating chamber condensing on the condensation plate and collected on the condensation collection pan for discharge through the outlet in the upper chamber.

13. The tank of claim 1, wherein the lower chamber further comprises:
a first chamber in communication with the middle heating chamber having at least one outlet, and
a second chamber in communication with the first chamber and having at least one outlet,
the first chamber allowing for sedimentation of fluid from the middle heating chamber to separate plant oil from the fluid received from the middle heating chamber, the first outlet positioned in the first chamber to direct plant oil to the second chamber for recovery via the at least one outlet in the second chamber.

14. The tank of claim 13, wherein the upper chamber includes one or more ports for introduction of cold fluid and/or compressed air to facilitate evaporation and condensation and/or for evacuation of the upper chamber.

15. The tank of claim 14, wherein the first chamber has an additional outlet to recycle fluid from the middle heating chamber or recover the fluid from the middle heating chamber or discharge sedimentary contamination from the first chamber.

16. The method of claim 4, wherein the heated fluid is recycled to the cavitation apparatus along with discharge from the middle heating chamber.

17. The method of claim 3, wherein the plant material is used in a raw form or in a form wherein the plant material is broken down to provide increased surface area.

18. The method of claim 4, wherein the lipid emulsion or the sterilized lipid emulsion is used as the fluid.
